(19) United States
(12) Patent Application Publication
(10) Pub. No.: US 2006/0122936 A1
(43) Pub. Date: Jun. 8, 2006

(54) System and method for secure publication of online content

(76) Inventor: Dirk Balfanz, Redwood City, CA (US)

Correspondence Address: AXIOM LEGAL SOLUTIONS, C/O PORTFOLIOIP, P.O. BOX 52050, MINNEAPOLIS, MN, 55402, US

(21) Appl. No.: 11/005,858

(22) Filed: Dec. 6, 2004

(51) Int. Cl. G06Q 99/00

(52) U.S. Cl. 705/51

(57) ABSTRACT

When content publishers announce the availability of new content to one or more recipients, a content server automatically authorizes only those recipients of the announcement to have access to the new content. The authentication of clients is managed in an automated and user-friendly fashion. This may include instantaneous issuance of certificates, as well as quick revocation of certificates should they have been issued to the wrong individual. Quick revocation is facilitated by the fact that identities are associated with public keys in an online database where the association can quickly be undone, rather than in the certificates themselves as is traditionally the case.

### TECHNICAL FIELD

This disclosure generally relates to data processing for file access, and in particular it relates to privileged access.

### BACKGROUND OF THE DISCLOSURE

On the World Wide Web, there are content providers and content consumers. Content providers publish content by making it available through web servers. Content consumers view content by pointing their web browsers to those web servers.

More and more users are becoming small content providers. For example, subscribers of various Internet Service Providers (ISPs) usually get a few megabytes of “web space,” which can be used to publish various types of content. Content publishing software and services, such as FRONTPAGE, APACHE WEBSERVER or .MAC, make it easy to publish content even for non-expert users. However, enforcing access control for such content still requires some level of expertise, and/or places unnecessary burden (such as remembering and typing passwords, dealing with a plethora of security settings, etc.) both on the content publishers and content consumers.

While it is now easier for small-time content providers to publish their content, it is not particularly easy to do so securely, i.e., in a manner that allows content providers to easily specify who should have access to their content. Large content providers can afford to manage databases of subscribed customers, request certificates from well known certification authorities, and hire developers to put access control mechanisms in place. Small content providers, however, often lack such resources and technical sophistication. They are thus left with three choices: do not put any access control on content, struggle with the various mechanisms that content publishing software provides for access control, or not publish content at all.

Recent research has focused on making access control systems more flexible and powerful, but not on making them easier to use. Accordingly, there is a need for a method and apparatus for secure publication of content that addresses certain deficiencies in existing technologies.

### SUMMARY OF THE DISCLOSURE

A method for securely distributing content online will now be introduced, in which a content server first receives content from a provider. The provider then transmits a notification, for example by e-mail or instant message, to at least one recipient regarding the available content. Based on the notification, the content server associates the content with the identification of the recipient in the notification, and stores this in, for example, an access database that may be used to control access to all content on the server.

When a first-time recipient selects a link to the content from the notification, a public key is generated on the recipient's terminal. In certain embodiments, the terminal generates a key pair, comprising the public key that is securely communicated to the server and a private key that is not communicated by the recipient to any third party. The server then associates the recipient with the public key, and may store the association in the access database. Such first-time recipients may then access the content anytime thereafter by using the generated key pair to authenticate themselves to the content server, without having to generate a new public key each time.

When a request is received from a user having a public key, an encrypted communication path is established and the content is served across the encrypted communication path. Each recipient may only have one public key for the content server, but that public key may be used for accessing all content on the server to which the recipient is entitled by various content providers.

Content providers may control access to content simply by adding or removing an association between the identification of valid recipients and the desired content in an access control list. In addition, fraudulent users may be prevented from accessing data by removing or replacing the association between the identification of valid recipients and any public key that is being fraudulently used.

### BRIEF DESCRIPTION OF THE DRAWINGS:

Further aspects of the present disclosure will be more readily appreciated upon review of the detailed description of its various embodiments, described below, when taken in conjunction with the accompanying drawings, of which:

FIG. 1 is a block diagram of an exemplary network over which the processes of the present disclosure may be performed;

FIG. 2 is a flowchart of an exemplary access process performed between content providers, content recipients and the content server of FIG. 1;

FIG. 3 is a flowchart of an exemplary access process performed by the content server of FIG. 1; and

FIG. 4 is a display of an exemplary graphical user interface for a content provider to notify recipients of new content on the content server of FIG. 1.

### DETAILED DESCRIPTION OF THE SPECIFIC EMBODIMENTS:

Access control systems will now be introduced which are easier to use for content providers who want to protect their content from unauthorized access, and for authorized content consumers who want hassle-free access to such protected content, than those processes found in existing systems. As will be described in detail in the following, the disclosed access control systems can be constructed with conventional building blocks, such as access control lists, databases, public/private keys and authentication certificates. The goal, in terms of usability, is the create-publish-announce cycle for publishing protected content in a secure system should be as close as possible to publishing unprotected content in an insecure system.

For ease of use in content publishing then, the access control steps introduced here are responsive to actions that content publishers usually perform anyway, and associate reasonable security mechanisms with them. For example, content providers usually go through a create-publish-announce cycle in which content first gets created (e.g., a hobby photographer takes pictures). Then, the content is published somewhere (e.g., the photographs are copied to a web hosting service). Finally, the content provider will announce that her content is online (e.g., send an e-mail with a link to the content to friends, family and the like). The access control systems disclosed herein assume that this last step also adequately describes the content provider's intention in terms of access control for protected content. The action of sending the message is then used to automatically establish who should have access to the published content in the disclosed processes.

Accessing protected content should also be identical to accessing unprotected content. That is, there should be no need to remember or type passwords, or any complex management of identity certificates in order to access content. For ease of use in accessing protected content then, according to the present system, content consumers will receive the message including the link, such as a hyperlink having a uniform resource locator (URL), to the protected content. Content consumers are used to accessing content in this manner. However, as now disclosed, the selection of the link by the content consumer will automatically cause her terminal to use necessary credentials to authenticate the content consumer to the content provider's web site, without any extensive interaction by the content consumer.

An Easy and Secure Content Authorization and Publishing Engine (ESCAPE) server is therefore provided to non-expert content providers and other users so that they may quickly specify access control for their stored content. ESCAPE uses the act of announcing the existence of new content as an indicator for access control (i.e. those who get the announcement are those that have access to the content). The ESCAPE server binds public keys to identities in an online database, which allows it to revoke certificates much more easily than in prior systems in which the public key is bound to an identity in public-key certificates, which leave the control of the server once issued. This, in turn, allows the ESCAPE server to be less careful when handing out certificates, thus making the enrollment process more user-friendly.

We know that a secure communication between content provider and content consumer is not possible without some a-priori shared trust information (e.g., a shared secret or password, or public key). Therefore, our usability goals necessarily prohibit an unconditionally secure solution. Instead, we strive for a level of security similar to that provided by SECURE SHELL (SSH). With SSH, the first time a client connects to a server, a man in the middle could hijack the connection and intercept all traffic from then on. But given that the presence of a malicious man-in-the-middle during the first handshake is unlikely, the usability gained outweighs the security lost. In ESCAPE, a similar level of security is achieved.

When interacting with the ESCAPE server, content consumers use a private key to establish encrypted communications. Security of the ESCAPE server can be subverted if the private key becomes known to third parties. However, content consumers are unlikely to share the private key with others, since it allows complete impersonation to all available content on the ESCAPE server, and not just access to certain content. Furthermore, in the ESCAPE system system, no sensitive information is ever exchanged insecurely.

The fact that the disclosed system only requires common software tools such as e-mail readers (e.g., MICROSOFT OUTLOOK) and Internet browsers (e.g., MICROSOFT INTERNET EXPLORER) for content providers and consumers, contributes to the ease of use of the system.

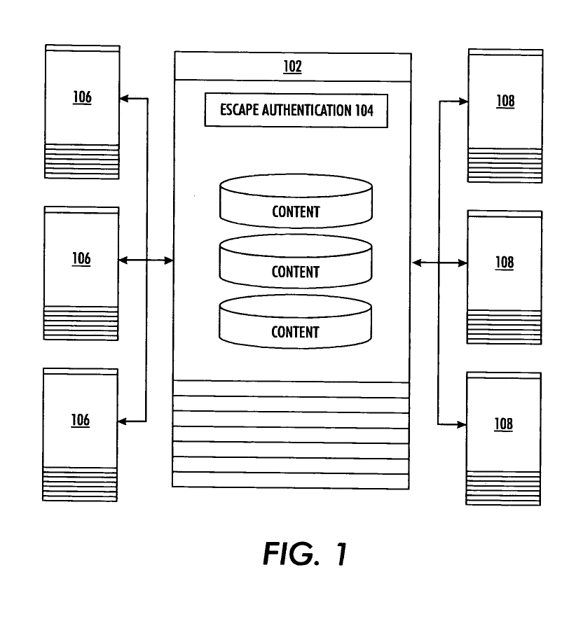

Referring now to FIGS. 1-4, wherein similar components of the present disclosure are referenced in like manner, various embodiments of a method and system for secure publication of online content are introduced. Turning now to FIG. 1, there is depicted an exemplary computer network 100, which includes an ESCAPE server 102 having software 104 and memory for storing data and content. The computer network 100 further includes a plurality of content provider terminals 106 and a plurality of content consumer terminals 108.

It is readily contemplated that computer network 100 may be any type of network over which computer data and instructions may be transmitted, including but not limited to, a local area network (LAN), a wide area network (WAN), a corporate intranet, a fiber optic network, a wireless network, the Internet, or any combination or interconnection of the same. The network 100 is also not necessarily restricted to the number of components, or their manner of interconnection, as shown in FIG. 1. The network 100 may also include various effective and well-known security measures, such as encryption and secure transmission protocols, to securely communicate data.

The content provider terminals 106 and content consumer terminals 108 may be any type of computing device that can communicate with server 104 over the computer network 100, in order for content publishers and content consumers, respectively, to accomplish the functions described herein. Accordingly, such terminals 106, 108 may each be a personal computer (PC), a desktop, palmtop, laptop or notebook computer, a workstation, a personal digital assistant (PDA), a wireless computing device with Internet access, or the like.

The ESCAPE server 104 may be any type of suitable computing device, including, for example, an enterprise network server of the type commonly manufactured by SUN MICROSYSTEMS or IBM CORPORATION, and having a processor and memory for storing and executing processing instructions necessary to complete the functions described herein. The processing instructions may be embodied in one or more computer programs stored on any suitable computer-readable medium, such as a hard disk drive, a random access or read-only memory, a floppy diskette, a compact disc, a digital versatile disc, an optical medium, or which may reside on devices across a computer network. The ESCAPE server 104 may also be a group of distributed servers rather than a single server as shown in FIG. 1. In various embodiments, the ESCAPE server 104 may be a web server, operated by a third-party or the content provider, and which serves out content through an encrypted data path using, for example, secure hypertext transfer protocol (HTTPS).

The ESCAPE server 104 keeps an access control list (ACL) for each directory of stored data and content that it serves out. Each access control list comprises the identities of those content consumers or recipients allowed to access the directory or data. Data associations between content consumers and available data or content, as well as identity associations between content consumers and their public keys, may be stored in one or more databases, such as in MICROSOFT ACCESS database formats.

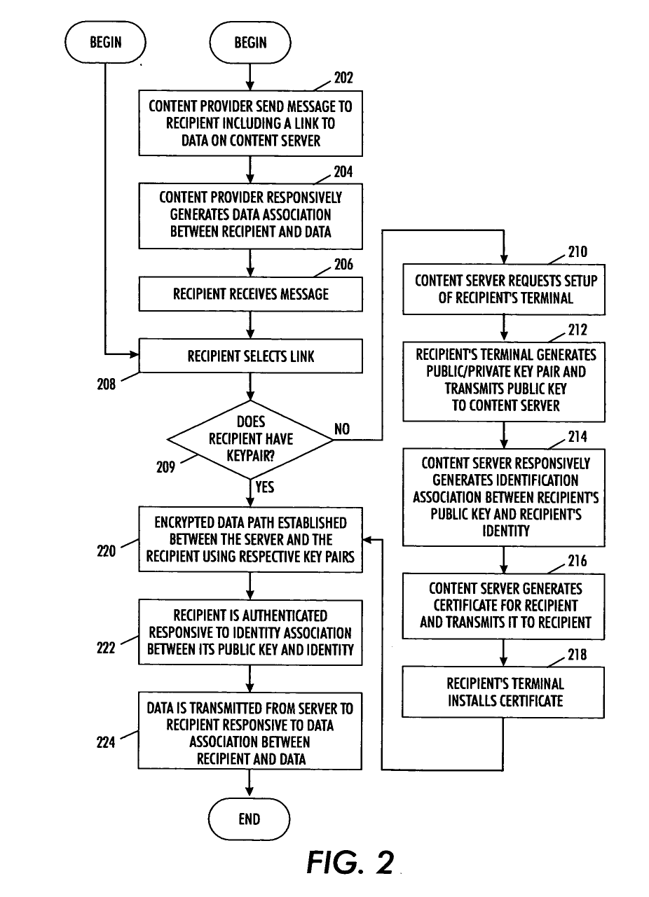

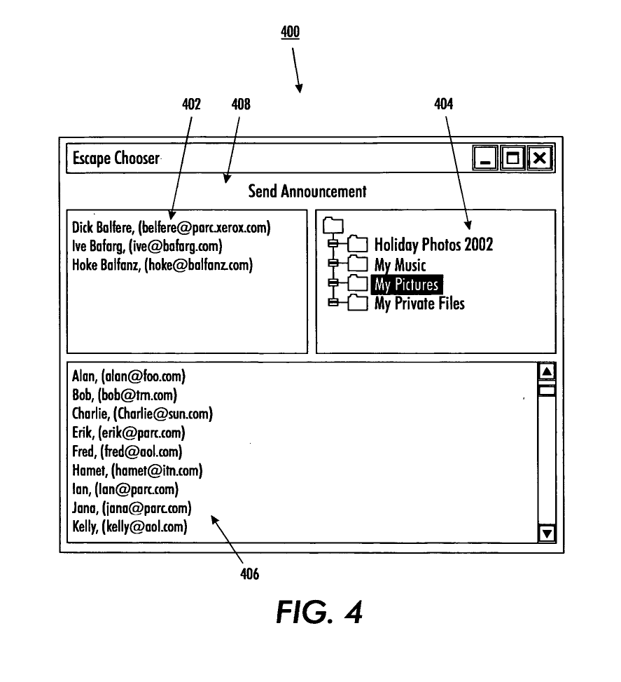

Turning now to FIG. 2, therein is depicted a first exemplary process 200 for providing access to data, performed between a content provider, an ESCAPE server 104 and content consumers (sometimes referred to herein as recipients). In order for a content publisher to publish content, all she has to do is upload -the data to the ESCAPE server 104. She then uses the ESCAPE server 104 to send out a notification (e.g., an e-mail or instant message) about the availability of the content (step 202). This may be accomplished by assigning recipients to the content using a graphical user interface (GUI) provided by the ESCAPE server 104, an example of which is described below with respect to FIG. 4. The message will contain a link, such as a hyperlink with an embedded network address or URL that recipients can click on to access the content.

For example, a URL for a recipient ‘Bob’ whose email address is bob(ibm may look something like this: https//alicescomputer.pacbell/holidayphotos?email=bob%40ibm. It might be accompanied by a message inviting Bob to access newly published content from ‘Alice.’

Responsive to step 202 above, the ESCAPE server 104 then generates a data association between every selected recipient and the newly created data (step 204). In certain embodiments, this data association can take the form of an access control list.

Upon receipt of the message by a recipient (step 206), the recipient can click on the link in the message (step 208), and will be taken to the ESCAPE server 104. The ESCAPE server 104 will require the recipient's terminal to establish an encrypted data path with the ESCAPE server 104. If the recipient already has an ESCAPE certificate (step 209), an encrypted data path is established between the ESCAPE server 104 and the recipient's terminal (step 220). If, however, the recipient does not have an ESCAPE certificate, upon visiting the content provider's ESCAPE server 104, the ESCAPE server will require a one-time setup procedure (step 210) that will generate a key pair comprising a public key and a private key via, for example, the recipient's web browser (step 212). The public key is communicated to the ESCAPE server 104 (step 212). In certain embodiments, this takes the form of a certificate request. The private key is maintained in secrecy by the recipient. The public key can be used for accomplishing encrypted communications with the ESCAPE server 104.

An identity association between the public key and client identity is not made in the certificate, but rather in a database on the ESCAPE server 104 (step 214). This is because there is need for a mechanism to quickly revoke wrongly issued certificates, as will be described later below.

In certain embodiments, the ESCAPE server 104 may respond to the recipient's public key by sending an ESCAPE certificate to the recipient (step 216). The ESCAPE certificate may include the recipient's public key. Note that the certificate sent by the ESCAPE server 104 doesn't actually certify any attributes or identification of the recipient (such as a name or email address). Unlike in many existing systems, it is an “empty” certificate, containing only the signed public key of the recipient.

In certain embodiments, the recipient installs the received certificate (step 218), and a message may be presented to the user that the setup is complete. Such message may also include a link to the original URL that the user can select to access the available content.

Whether or not the recipient had an ESCAPE certificate in step 209, at this point the recipient's terminal will be ready to establish an encrypted data path between the recipient and the ECLIPSE server 104 (step 220), revealing the public key of the recipient to the ESCAPE server 104. In certain embodiments, this establishment is done through standard cryptographic protocols such as SSL or TLS. The recipient is then authenticated based on the established identity association (step 222), and the requested data is transmitted to the recipient so long as the recipient remains associated with the data in the access list (step 224). Upon receipt of the data by the recipient, the process 200 ends.

Upon subsequent visits to the URL received in the email announcement, or any other URL on the provider's ESCAPE server, the process 200 starts at step 206. Furthermore, no setup steps 210 through 218 are necessary for any recipient who has established a public key with the ESCAPE server 104. Instead, the recipient is directly served the requested content so long as the valid public key is provided and the recipient's identity remains listed in the corresponding access control list.

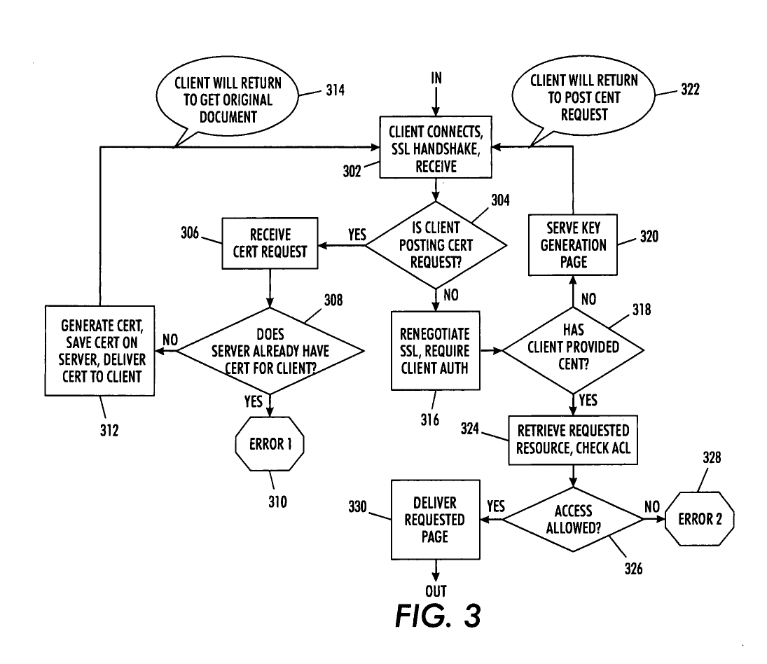

Turning now to FIG. 3, therein is depicted a flowchart of an access process 300 performed by an exemplary embodiment of the ESCAPE server 104 in response to a content consumer's request for data. Other embodiments that do not use SSL or certificates can be readily appreciated. The process commences when a recipient transmits a request for data to the ESCAPE server 104 (step 302).

In certain embodiments, the ESCAPE server 104 immediately starts a secure sockets layer (SSL) handshake without requiring client authentication. In embodiments where the ESCAPE server 104 uses a self-signed certificate, as described below with respect to FIG. 4, the recipient will see a dialog box that informs her of the issuance of the server's certificate. The recipient then has to acknowledge this, which will cause the SSL handshake to be completed.

Next, at step 304, the ESCAPE server 104 decides whether the recipient is posting a request for a certificate (in the case of a first-time user) or a request for actual data. If the former, the process 300 continues to step 306 below. If the latter, the process 300 continues to step 316, described later below.

At step 306, the ESCAPE server 104 receives the certificate request (step 306) and determines whether there already exists an association between the recipient's identity and the recipient's public key. In certain embodiments, that public key is stored in a certificate for the recipient (step 308). If there is no existing certificate, the process 300 continues to step 312 below. Otherwise, at step 310, an error condition (Error 1) is identified.

If there is no such association for the recipient, the ESCAPE server 104 creates and stores such an association between the recipient's identity and its public key. In certain embodiments, it also generates a certificate and sends it to the recipient's terminal 104 (step 312). After the delivery of the public key contained in said certificate, the recipient returns to the ESCAPE server 104 to retrieve the content (step 314) and the process 300 commences again at step 302 above.

Returning to step 304 of the process 300, when the client is not posting a certificate request, and is instead seeking content, the process 300 continues in the following manner.

In an embodiment involving SSL, the process 300 may include a renegotiation of the SSL handshake of the client and a requirement for client authentication (step 316). The ESCAPE server 104 then determines whether a valid public key for the recipient has been provided by the recipient (step 318).

If the recipient doesn't provide a public key, the recipient is not served the page it requested, and instead it is served a page that informs the recipient that a one-time setup is needed (step 320), after which the client generates a key pair comprising a public key and a private key and posts a certificate request containing the public key (step 322) and the process 300 returns to step 302 above.

If, on the other hand at step 318 above, the recipient does provide a valid public key, the process 300 continues to step 324 where the requested content or data is retrieved. The recipient's identity is determined responsive to the association establish in step 312. The access control list for the requested data created in step 204 is checked at step 326 to determine whether the recipient is authorized to receive the content. If not, the process 300 returns an ‘Error 2’ condition (step 328), after which the process 300 ends. If, on the other hand, access is allowed, the requested data is sent to the recipient (step 330) over an encrypted data path which uses the key pair generated by the recipient, after which the process 300 terminates.

FIG. 3 singles out two error conditions above, marked as “Error 1” and “Error 2”. While ESCAPE server 104 checks for other error conditions, these are especially interesting. Error 2 is simply the error raised when a client tries to access a resource it is not authorized to view (but has a valid ESCAPE certificate). Error 1 has to do with revocation.

As mentioned before, the security provided by the ESCAPE server 104 is not absolute. For example, an announcement email sent to a recipient could be intercepted by a malicious man-in-the-middle. A fraudulent user could access the ESCAPE server 104 before the legitimate recipient could, thus essentially assuming the legitimate user's identity. This is because the ESCAPE server 104 issues certificates immediately to whoever asks for them first. When, however, the legitimate recipient later tries to access the ESCAPE server 104, she will trigger Error 1.

The page served out under the Error 1 condition says that legitimate users should contact the content provider or operator of the ESCAPE server 104. If and when the legitimate recipient does so, the fraudulent public key received for that recipient, and associated with that recipient's identity in step 312, is removed from the database.

Now, when the legitimate recipient visits the ESCAPE server again, she will be taken through the setup process, and her public key will be associated with her identification in the database maintained by the ESCAPE server 104. This revokes the public key received from the man-in-the-middle that was fraudulently associated with the legitimate recipient. The same mechanism can be used to revoke users permanently, for whatever reason.

In certain embodiments, the ESCAPE server 104 maintains an established key pair, comprising a public and a private key that it uses to authenticate itself to content consumers, and to issue certificates for content consumers. The public key of the ESCAPE server 104 can either be a self-certified or “trusted root” certificate, or can be certified by a well-known certification authority.

Turning now to FIG. 4, therein is depicted an exemplary GUI 400 used by a content provider to post and announce content. The upper right pane 404 shows the file system of the ESCAPE server 104 in which available content from the content provider is stored. The content provider can browse to the directory that contains the new content, and select from the list of all known contacts (shown in the lower half 406 of the window) those that should receive an announcement about the new content. Those recipients chosen are simply dragged into the ACL 402, shown in the upper left pane of GUI 400. The content provider then navigates to the newly created content directory, picks a list of recipients (e.g. from an electronic address book), and presses a “Send Announcements” button 408 to transmit notifications to the selected recipients. Other embodiments of the user interface are readily appreciated.

It is very easy to remove clients from an access control list. Using the GUI 400, the content provider simply has to navigate to the published folder in question shown in upper right pane 404, and remove unwanted clients from the access control list 402.

In various embodiments described in the foregoing, each recipient has one and only one public/private key pair per ESCAPE server 104, which is the credential that enables access to all content on that server. Therefore, this facet provides some disincentive to share private keys with other people.

In the disclosed embodiments above, the requirement that there can only be one public key per recipient prevents fraudulent users from acquiring certificates for an identity, once a legitimate recipient has received her certificate. The same mechanism prevents legitimate recipient from receiving a second certificate, say, for a second computer they own. Instead, recipients must copy their key pair or certificate to each terminal 108 they want to use.

Another security issue with the system presented above is the way it delivers certificates to recipients. A more secure way would be to e-mail certificates to the e-mail address presented at certificate request time by the recipient. This would raise the bar significantly for an attacker who wanted to impersonate other parties to an ESCAPE server 104. However, this would adversely affect the usability of the system. First of all, there would be no immediate access to the content when a recipient first receives the announcement of the content's availability. Upon connecting to the ESCAPE server 104, the recipient would also have to wait for a second e-mail delivering the certificate. Furthermore, the installation of a certificate that is sent per email is considerably more involved than installation of a certificate from a web page. Given that the window of opportunity for an attacker in our scheme lasts only until the legitimate user first contacts the ESCAPE server 104, the usability gained by the disclosed system offsets the security lost.

Although the best methodologies have been particularly described in the foregoing disclosure, it is to be understood that such descriptions have been provided for purposes of illustration only, and that other variations both in form and in detail can be made thereupon by those skilled in the art without departing from the spirit and scope thereof, which is defined first and foremost by the appended claims.

What is claimed is:

1. A computer controlled method for controlling access to data on a server comprising steps of:
maintaining a data association at said server between a recipient and said data;
activating a link at a client by said recipient to access said data;
maintaining an identity association between a public key and said recipient;
establishing an encrypted data path between said client and said server;
authenticating said recipient responsive to said identity association; and
transferring said data across said encrypted data path responsive to said data association.

2. The method of claim 1, further comprising:
sending a message to the recipient, the message including the link to said data.

3. The method of claim 2, further comprising:
establishing the data association responsive to said message.

4. The method of claim 2, further comprising:
receiving said message at said client.

5. The method of claim 1, further comprising:
generating, at said client, a key pair including the public key and a private key, responsive to said activating; and
transmitting the public key to said server.

6. The method of claim 5, further comprising:
generating, at said server, the identity association between said recipient and said public key responsive to said transmitting.

7. A computer controlled method for controlling access to data comprising steps of:
maintaining a data association between a recipient and said data;
maintaining an identity association between a public key and said recipient;
establishing an encrypted data path responsive to a communication request;
authenticating said recipient responsive to said identity association; and
sending said data across said encrypted data path responsive to said data association.

8. The method of claim 7, further comprising:
sending a message to the recipient, the message including a link to said data.

9. The method of claim 8, further comprising:
establishing the data association responsive to said message.

10. The method of claim 8, further comprising:
receiving said message by said recipient.

11. The method of claim 7, said maintaining an identity association further comprising:
receiving the public key from the recipient; and
generating, at said server, the identity association between said recipient and said public key responsive to said receiving.

12. The method of claim 11, further comprising:
transmitting a certificate to said recipient responsive to said generating.

13. The method of claim 12, further comprising:
installing the certificate at a client of the recipient.

14. A computer-readable medium encoded with processing instructions for implementing a method, performed by a computer, the method comprising:
maintaining a data association between a recipient and said data;
maintaining an identity association between a public key and said recipient;
establishing an encrypted data path responsive to a communication request;
authenticating said recipient responsive to said identity association; and
sending said data across said encrypted data path responsive to said data association.

15. The computer-readable medium of claim 14, said method further comprising:
sending a message to the recipient, the message including a link to said data.

16. The computer-readable medium of claim 15, said method further comprising:
establishing the data association responsive to said message.

17. The computer-readable medium of claim 15, said method further comprising:
causing a communications mechanism of the recipient to receive said message.

18. The computer-readable medium of claim 14, said method further comprising:
receiving the public key from the recipient; and
generating the identity association between said recipient and said public key from the recipient.

19. The computer-readable medium of claim 18, said method further comprising:
transmitting a certificate to said recipient.

20. The computer-readable medium of claim 19, said method further comprising:
causing an installation mechanism of the recipient to install the certificate.

21. An apparatus comprising:
a storage mechanism configured to maintain a data association between a recipient and data, and to maintain an identity association between a public key and said recipient;
an encryption mechanism configured to establish an encrypted data path responsive to a communication request;
an authentication mechanism configured to authenticate said recipient responsive to said identity association; and
a communications mechanism configured to send said data across said encrypted data path responsive to said data association.
